(19) United States
(12) Patent Application Publication
(10) Pub. No.: US 2016/0230980 A1
(43) Pub. Date: Aug. 11, 2016

(54) NOVELTY DEVICE WITH ILLUMINATED CHANNEL

(71) Applicant: Group-JDS, Ltd. (HK), Kowloon (HK)

(72) Inventor: Christian Brayian Roos, Quito (EC)

(21) Appl. No.: 14/808,879

(22) Filed: Jul. 24, 2015

Related U.S. Application Data
(60) Provisional application No. 62/112,499, filed on Feb. 5, 2015.

(51) Int. Cl. F21V 33/00; F21V 23/04; F21V 23/00

(52) U.S. Cl. CPC F21V 33/0004; F21V 33/008; F21V 23/003; F21V 23/04; F21Y 2101/02

(57) ABSTRACT

A novelty device is provided. The novelty device includes a body having a base section formed from a foam material. A channel is formed in the base section. The novelty device also includes an illuminating unit disposed within the channel. The illuminating unit includes a light-transmissive housing having one or more illuminating elements disposed therein.

### BACKGROUND

The following description relates to a novelty device, for example, a novelty device with an illuminated channel.

Novelty items may be made in different shapes and sizes. For example, novelty devices may be shaped and/or sized to resemble other devices for use such as props, entertainment or training purposes. The novelty items are often formed from a lightweight, durable and/or resilient material, and may be suitable for use by persons of nearly any age.

Conventional novelty items, such as those described above, may also include a graphic or pattern printed o applied thereon. Further, some novelty items may include lights. The lights may be provided, for example, to simulate a state of operation, to indicate a state of operation, or for visual effects. The lights may be, for example light emitting diodes (LEDs).

However, in some novelty items, the lights are externally mounted and may be subjected to impacts against external objects. As such, the lights may be damaged or become unusable. In addition, in some novelty devices, the lights may be individually mounted, and thus, may need power individually supplied thereto. Thus, in the known configurations, multiple electrical connections must be provided between the individual lights and a power supply.

Accordingly, it is desirable to provide an illuminated novelty device with simplified circuitry and increased durability.

### SUMMARY

According to one embodiment, a novelty device includes a body having a base section formed from a foam material, the base section having a channel formed therein. The device further includes an illuminating unit disposed within the channel. The illuminating unit includes a light-transmissive housing having one or more illuminating elements disposed therein.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 is a top view of a novelty device according to an embodiment described herein;

FIG. 2 is a view of an inner section the novelty device shown in FIG. 1;

FIG. 3 is a perspective view showing a portion a side and inner section of the novelty device of FIG. 1;

FIG. 4 is an enlarged view of a portion of the novelty device of FIG. 1;

FIG. 5 is a profile view of a novelty device providing an example of a visual effect according to another embodiment described herein;

FIG. 6 is a profile view of the novelty device of FIG. 6 providing a different example of a visual effect;

FIG. 7 is a profile view of the novelty device of FIG. 5 providing a different example of a visual effect; and

FIG. 8 is a perspective view of a novelty device according to an embodiment described herein.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

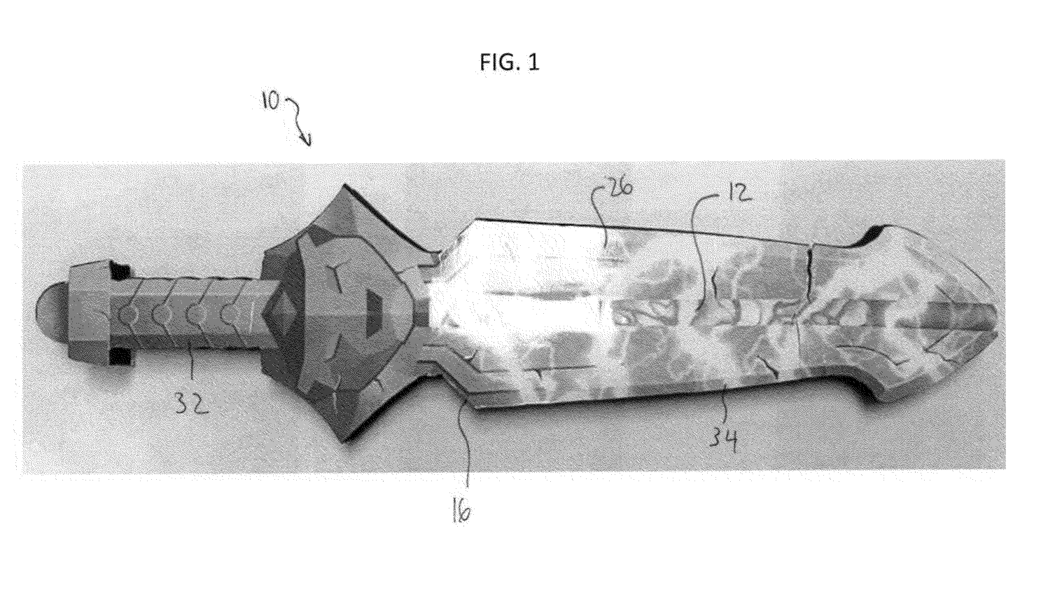

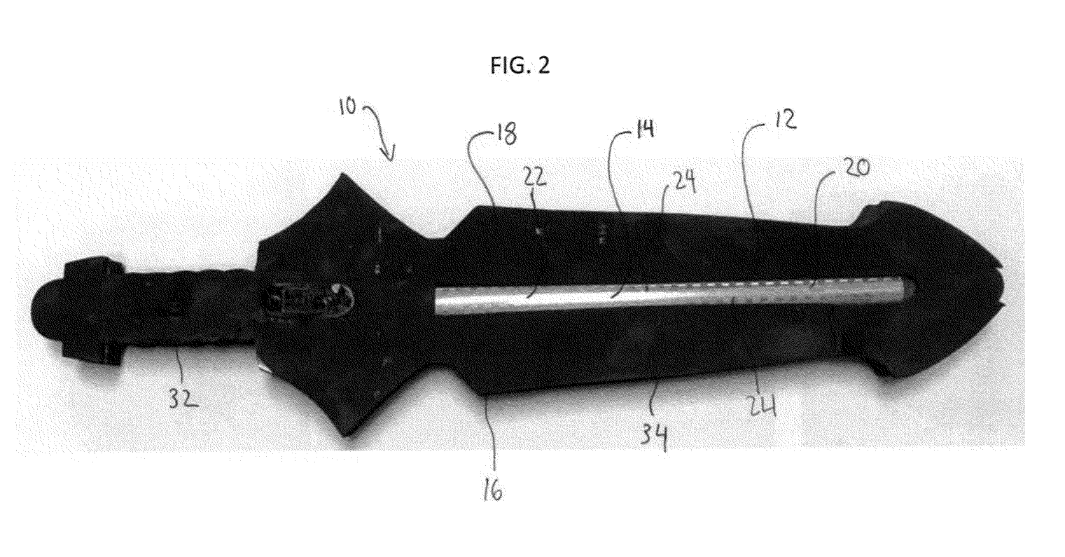

FIGS. 1 and 2 are plan views of a novelty device 10 having a channel 12 for receiving an illuminating unit 14 therein. Referring to FIGS. 1 and 2, the novelty device 10 includes a body 16. In one embodiment, the body 16 includes a base section 18 that may be formed from a relatively lightweight and flexible material, such as a foam material. A suitable foam material may include, for example, a polymer foam and the like. However, it is understood the base section 18 described herein is not limited to polymer foams, and other suitable materials may be used in the construction of the base section 18, such as lightweight plastics or rubber.

FIG. 2 shows an internal section of the novelty device 10. Referring still to FIGS. 1 and 2, the channel 12 is formed in the base section 18. In one embodiment, the channel 12 extends in a longitudinal or length direction of the base section 18. In addition, the channel 12 may extend through an entire thickness of the base section 18. Alternatively, the channel 12 may extend only partially through a thickness of the base section 18. In some embodiments, more than one channel 12 may be formed in the base section 18, with one or more illuminating units 14 disposed in each channel 12.

The illuminating unit 14 is disposed in the channel 12 and may be received therein via an opening or open side 20 of the channel 12. The illuminating unit 14 may be generally tube-shaped. For example, the illuminating unit 14 may be formed generally as an elongated cylinder. However, the illuminating unit is not limited to such a configuration. For example, the illuminating unit 14 may be curved, angled or formed in a closed or substantially closed loop or geometric shape. In addition, the illuminating unit 14 may include a housing 22 formed of a light-transmissive material, such as a transparent or translucent material. The housing 22 may include a light refracting or other light-distorting treatment, material or pattern thereon.

The illuminating unit 14 further includes one or more illuminating elements 24 disposed therein. In one embodiment, the illuminating elements 24 may be one or more light emitting diodes (LEDs), incandescent bulbs, or other similar, suitable elements. Alternatively, or in addition, the illuminating elements 24 may include a chemiluminecsent material. The illuminating elements 24 are configured to provide a visual effect. In one embodiment, the illuminating elements 24 may, for example, provide different colors, vary in brightness and/or blink.

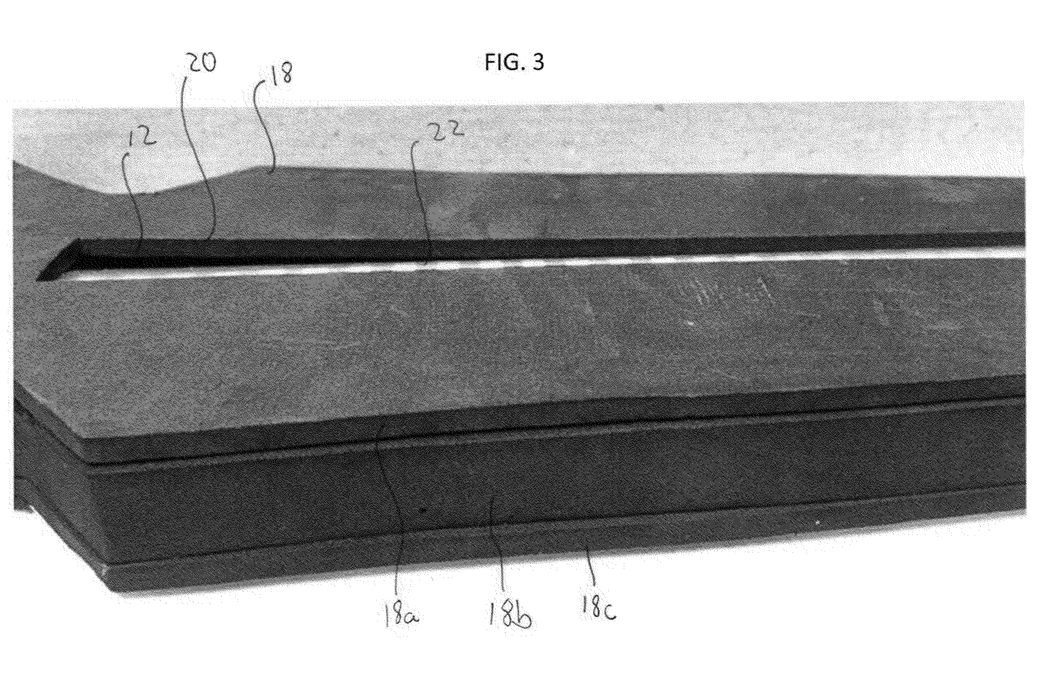

FIG. 3 is a perspective view showing a portion of the novelty device 10 of FIG. 1. Referring to FIGS. 1-3, the base section 18 may be formed of one or more layers of material. For example, as shown in FIG. 3, the base section 18 may be formed by three layers of material 18a, 18b, 18c adhered to one another. The channel 12 may extend completely through each layer 18a, 18b, 18c.

In addition, referring to FIG. 1, the body 16 may also include an outer layer 26 disposed over at least a portion of the base section 18. For example, the outer layer 26 may extend over oppositely facing sides of the base section 18. That is, the outer layer 26 may be formed of separate pieces to cover different surfaces or portions of different surfaces of the base section 18. Alternatively, the outer layer 26 may extend substantially or entirely around an entirety of the base section 18. The outer layer 26 may be sized and shaped generally correspond to a size and shape of the base section 18.

In one embodiment, the outer layer 26 may extend over and cover the open sides 20 of the channel 12. The outer layer 26 may be a relatively thin, flexible material such as plastic, plastic film, or the like, and may be adhered to the base section 18. In addition, the outer layer 26 may be light-transmissive such that a visual effect produced by the illuminating unit 14 is visible through the outer layer 26. For example, the outer layer 26 may be transparent or translucent. Moreover, the outer layer 26 may include a graphic or graphics printed or formed thereon. The outer layer 26 may also include holographics printed thereon. For example, in one embodiment, the outer layer 26 may be substantially transparent or translucent and include a holographic print.

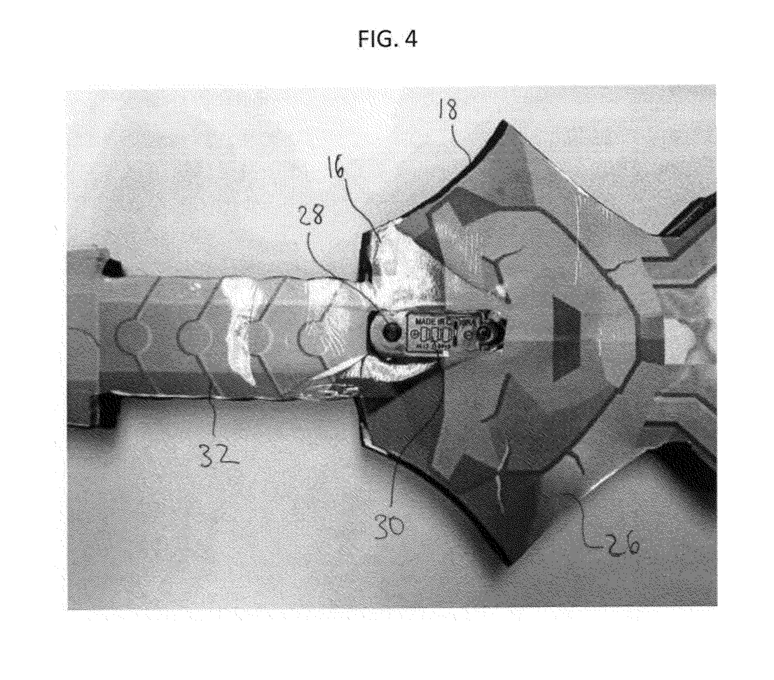

FIG. 4 shows a portion of the novelty device 10 of FIG. 1. Referring to FIGS. 1-4, the novelty device 10 may also include a switch 28 to actuate the illuminating unit 14. The switch 28 may actuate the illuminating unit 14 between different conditions where different visual effects may be provided by the illuminating elements 24. For example, the switch 28 may be used actuate the illuminating unit 14 between a first condition where the illuminating elements 24 blink at a first frequency, a second condition where the illuminating elements 24 blink at a second frequency different from the first frequency, a third condition where the illuminating elements 24 are illuminated and not blinking, and an OFF condition. It is understood, however, the present description is not limited to these conditions. For instance, the illuminating unit 14 may be actuated between other conditions. Such other conditions may include, but are not limited to, the illuminating unit 14 and/illuminating elements 24 displaying different colors, blinking at different frequencies and/or blinking in different patterns.

The novelty device 10 may also include a controller 30 electrically and communicatively connected to the switch 28 and the illuminating unit 14. The controller 30 is configured to control the illuminating unit 14 to provide different visual effects. For example, the controller 30 may control a frequency of blinking and/or color of the illuminating elements 24 in the illuminating unit 14 in response to actuation of the switch 28. The controller 30 may be programmed with operating conditions for the illuminating unit 14, and may also store the programmed operating conditions. Different operating conditions correspond to different visual effects provided by illuminating unit 14. Accordingly, the controller is configured to control operation of the illuminating unit 14 to provide different visual effects corresponding to the desired operating condition. The switch 28 may be actuated to change between different conditions stored at the controller 30.

In one embodiment, the body 16 of the novelty device 10 includes a handle 32 and a housing section 34. The channel 12 may be disposed in the housing section 34, but is not limited thereto. For example, the channel 12 may extend in both the housing section 34 and the handle 32. Alternatively, multiple channels 12 may be formed in the body 16 and may be disposed in the housing section 34, the handle 32 or both. Referring to the embodiments in FIGS. 1-4, for example, the handle 32 and the housing section 34 may be substantially axially aligned. In such a configuration, the handle 32 and housing section 34 may be shaped to resemble, for example, a sword or the like, so as to form a novelty sword that provides a visual effect via the illuminating unit 14.

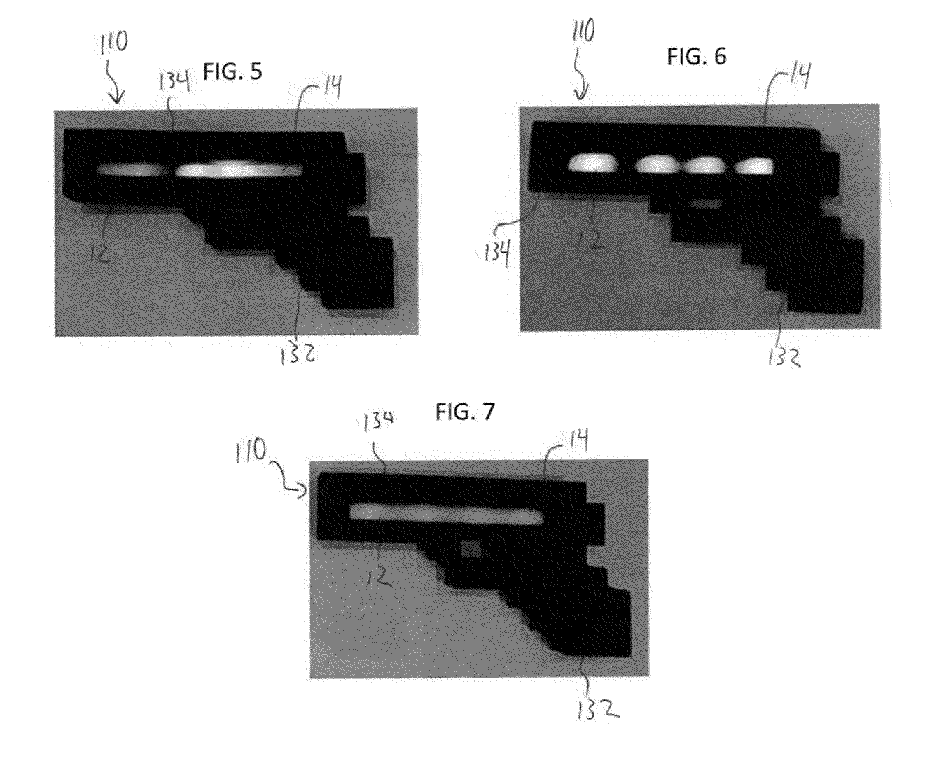

However, the present disclosure is not limited to the configuration described in the embodiments above. For example, FIGS. 5-8 show alternative configurations of a novelty device 110. It is understood that features described in the embodiments above may be included in or used together with the embodiments described below. In addition, it is understood that where features similar or identical to those described above are included in the embodiments below, further description may be omitted, and/or similar reference characters may be used.

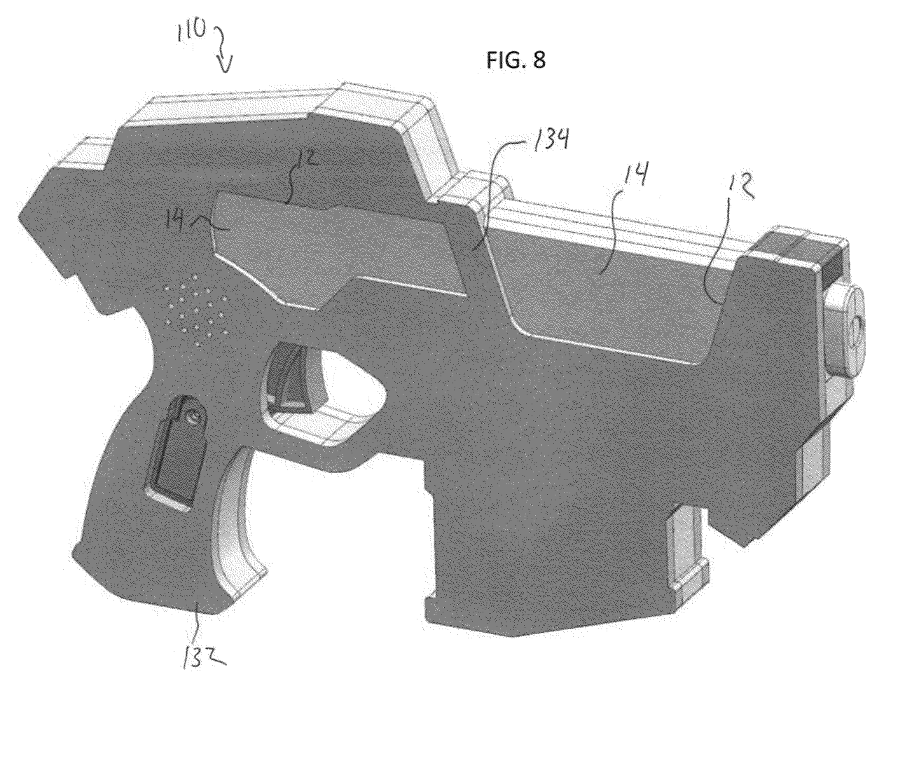

FIGS. 5-7 show the novelty device 110 having an illuminating unit providing examples of different visual effects. FIG. 8 shows a variation of the novelty device 110 of FIGS. 5-7. Referring to FIGS. 5-7, the handle 132 and the housing section 134 are formed similarly to the handle 32 and housing section 34 described above, and further description is omitted below. However, in FIGS. 5-7, the handle 132 the housing section 134 may be angled relative to one another. That is, the handle 132 and the housing section 134 may extend along respective axes that are angled relative to one another. Accordingly, in such a configuration, the body 16, i.e., the handle 132 and the housing section 134 may be shaped to resemble, for example, a novelty firearm or the like, that provides a visual effect via the illuminating unit 14. As described in the embodiments above, the illuminating unit 14 may be controlled by the controller 30 and actuated by the switch 28 to provide different visual effects.

Further, referring to FIG. 8, it is understood that the handle 132 and housing section 134 are not limited to the configurations above. For example, the housing section 134 may include a channel 12 having one or more open sides 20, and one or more of the open sides 20 may extend at least partially around a perimeter of the illuminating unit 14. In addition, the illuminating unit 14 may be formed in shapes different than those described above. For example, the illuminating unit 14 may be substantially square or rectangular in cross-section.

The novelty devices 10, 110 described above may also include a receptacle configured to receive a power supply, such as a battery or battery pack. The receptacle may include an electrical connection configured to connect the power supply to the controller 30 and illuminating element 24 so that a current may flow therebetween.

It is understood that the body 16 is not limited to the shapes and configurations described above and shown in FIGS. 1-8. In addition, it is understood that the body 16 is not limited handle and housing section configurations described above, and that in some embodiments, one of the handle or housing section may be omitted. Alternatively, the handle and housing section may be formed as one and the same. For example, in some embodiments, the body 16 may formed substantially in the shape of a wand or a necklace, to form a novelty wand or necklace having an illuminating unit 14 disposed in a channel 12. Other shapes and configurations for the body 16 are envisioned as well, including but not limited to, shields and pendants for use on a necklaces.

Accordingly, in the embodiments above, one or more illuminating elements 24 may be housed in a housing 22 of an illuminating unit 14. The illuminating unit 14 may be positioned in a channel 12 so that it is recessed in a body 16 of the novelty device, and thus, may be protected from impact with external objects. Further still, a single electrical connection may be made between each of the illuminating unit 14, controller 30, switch 28 and/or power supply, which may allow for easier and quicker manufacturing and assembly and reduced material costs. For example, a single electrical connection may be made to the illuminating unit 14, rather than individual connections for each illuminating element 24 to the controller 30, switch 28 and/or power supply.

It should also be understood that various changes and modifications to the presently disclosed embodiments will be apparent to those skilled in the art. Such changes and modifications can be made without departing from the spirit and scope of the present disclosure and without diminishing its intended advantages. It is therefore intended that such changes and modifications be covered by the appended claims.

1. A novelty device comprising:
a body having a base section formed from a foam material, the base section having a channel formed therein; and
an illuminating unit disposed within the channel, the illuminating unit comprising a light-transmissive housing having one or more illuminating elements disposed therein.

2. The novelty device of claim 1, wherein the body includes a handle.

3. The novelty device of claim 2, wherein the body includes a housing section extending from the handle, and the channel is formed in the housing section.

4. The novelty device of claim 3, wherein the handle and housing section are axially aligned such that the body is formed generally in a shape of a novelty sword.

5. The novelty device of claim 3, wherein the handle and housing section are angled relative to one another such that the body is generally formed generally in a shape of a novelty firearm.

6. The novelty device of claim 1, wherein the one or more illuminating elements includes one or more light emitting diodes (LEDs).

7. The novelty device of claim 1, wherein the one or more illuminating elements includes a chemiluminescent material.

9. The novelty device of claim 1, wherein the body further comprises an outer layer disposed over at least a portion of the base section and the channel, wherein the outer layer is formed from a light-transmissive material.

10. The novelty device of claim 1, wherein the outer layer is adhered to the base section.

11. The novelty device of claim 1, wherein the base section is formed by two or more layers of foam material, the channel formed in each layer.

12. The novelty device of claim 1, further comprising a controller electrically and communicatively connected to the illuminating unit and configured to control operation of the illuminating elements.

13. The novelty device of claim 1 wherein the foam material is made from a polymer.

14. The novelty device of claim 1, further comprising a switch to selectively actuate the illuminating elements.

15. The novelty device of claim 1, wherein the body is formed generally in the shape of a novelty wand.

16. The novelty device of claim 1, wherein the body is formed generally in the shape of a novelty necklace.
